(19) United States
(12) Patent Application Publication
(10) Pub. No.: US 2011/0140471 A1
(43) Pub. Date: Jun. 16, 2011

(54) Folding Motorcycle Mirror

(76) Inventor: Ned Suesse, Colorado Springs, CO (US)

(21) Appl. No.: 12/636,208

(22) Filed: Dec. 11, 2009

(51) Int. Cl. B60R 1/02; B60R 1/00; F16M 13/00

(52) U.S. Cl. 296/1.11; 248/476; 248/636

(57) ABSTRACT

A folding motorcycle mirror includes, a mirror assembly including a first ball, a mount assembly including a second ball, and a clamp assembly engaging the first ball and the second ball.

### FIELD OF THE INVENTION

This disclosure relates generally to a folding motorcycle mirror including at least two joints between the reflective surface and the motorcycle.

### BACKGROUND OF THE INVENTION

For motorcycles that are ridden both on-highway and off-highway, the position of the rider changes as the terrain does. When the terrain is smooth or the motorcycle is being operated on-highway, the rider generally remains seated and requires at least one rearview mirror to monitor nearby traffic. When the motorcycle is ridden off-highway traffic is generally not a concern, and the rider often stands to control the motorcycle through rough terrain.

When the rider stands, the angle of his arm changes relative to the handlebar, and having the mirror positioned over the bar may lead to interference between the rider's arm and the mirror stalk or body, leading to discomfort, the potential for injury to the rider, and the potential for damage to the mirror or to the motorcycle where the mirror connects to the handlebar. In addition, in the event the motorcycle is dropped or comes into contact with an obstruction, the mirror is prone to breakage in this upright position.

For these reasons, several designs of folding mirrors have been developed in the past. Known mirrors may include a pivot of limited range located immediately behind the reflective surface. The pivot may be used to adjust the view seen by the rider. There are known mirrors that also include a hinge somewhere along the shaft between the mirror and the mounting point on the motorcycle, used to fold the mirror down when not in use.

These known designs all share common shortcomings. First, the hinge or pivot is typically insufficiently sturdy, and breakage often occurs. Second, the pivot or hinge does not have adjustable tension, so that the mirror is difficult to position, yet insufficiently rigid to remain in place with sustained vibration and bump loading. Third, the pivot or hinge may allow for the mirror to be folded away when not in use, but because the shaft retains its shape and the mirror cannot be twisted relative to the base, it remains above the handlebar and often in the way of seeing the speedometer or other instruments. Furthermore, the hinge or pivot typically moves in only one plane, which further limits the adjustability for the folded position when that plane is correct for the extended position.

For these and other reasons, there exists a need for an improved folding motorcycle mirror.

### BRIEF DESCRIPTION OF THE INVENTION

The above-mentioned shortcomings, disadvantages and problems are addressed herein which will be understood by reading and understanding the following specification.

In an embodiment, a folding motorcycle mirror includes, a mirror assembly including a first ball, a mount assembly including a second ball, and a clamp assembly engaging the first ball and the second ball.

In another embodiment, a folding motorcycle mirror includes a reflective surface connected to a first ball by a stalk, a mount assembly connected to a second ball by a waist, a clamp assembly connecting the first ball to the second ball. The clamp assembly includes a first member, a second member, and a tensioning mechanism. The clamp assembly is configured to allow the first ball to rotate with respect to the first member, and the second ball to rotate with respect to the first member.

In another embodiment, a folding motorcycle mirror includes a mirror assembly with a reflective surface and a first ball, a mount assembly with a second ball, and a clamp assembly configured to allow the reflective surface to be positioned either in an extended position or in a folded position.

Various other features, objects and advantages of the invention will be made apparent to those skilled in the art from the accompanying drawings and detailed description thereof.

### BRIEF DESCRIPTION OF THE DRAWINGS

FIG. 1 is a schematic representation of a folding motorcycle mirror in accordance with an embodiment;

FIG. 2 is a schematic representation of a detailed exploded view of a folding motorcycle mirror in accordance with an embodiment;

FIG. 3 is a schematic representation of a folding motorcycle mirror in an extended position in accordance with an embodiment;

FIG. 4 is a schematic representation of a folding motorcycle mirror in a folded configuration in accordance with an embodiment;

FIG. 5 is a schematic representation of a detailed cross-sectional view of a mirror assembly of a folding motorcycle mirror in accordance with an embodiment;

FIG. 6 is a schematic representation of a detailed cross-sectional view of a mirror assembly of a folding motorcycle mirror in accordance with an embodiment;

FIG. 7 is a schematic representation of a detailed view of a clamp assembly of a folding motorcycle mirror in accordance with an embodiment;

FIG. 8 is a schematic representation of a detailed view of a clamp assembly of a folding motorcycle mirror in accordance with an embodiment;

### DETAILED DESCRIPTION OF THE INVENTION

In the following detailed description, reference is made to the accompanying drawings that for a part hereof, and in which is shown by way of illustration specific embodiments that may be practiced. These embodiments are described in sufficient detail to enable those skilled in the art to practice the embodiments and it is to be understood that other embodiments may be utilized that logical, mechanical, electrical and other changes may be made without departing from the scope of the embodiments. The following detailed description is, therefore, not to be taken as limiting the scope of the invention.

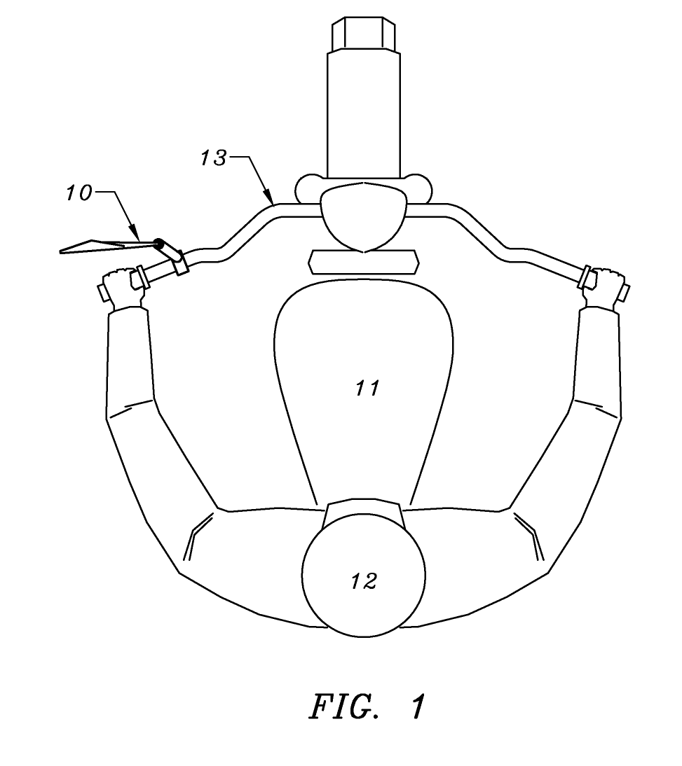

Referring to FIG. 1, a schematic representation is shown of a folding motorcycle mirror 10 attached to a motorcycle 11 according to an embodiment. A rider 12 is pictured to show the relative position of the folding motorcycle mirror 10 in an extended position, and a handlebar 13 is shown to illustrate where the folding motorcycle mirror 10 is mounted in this embodiment.

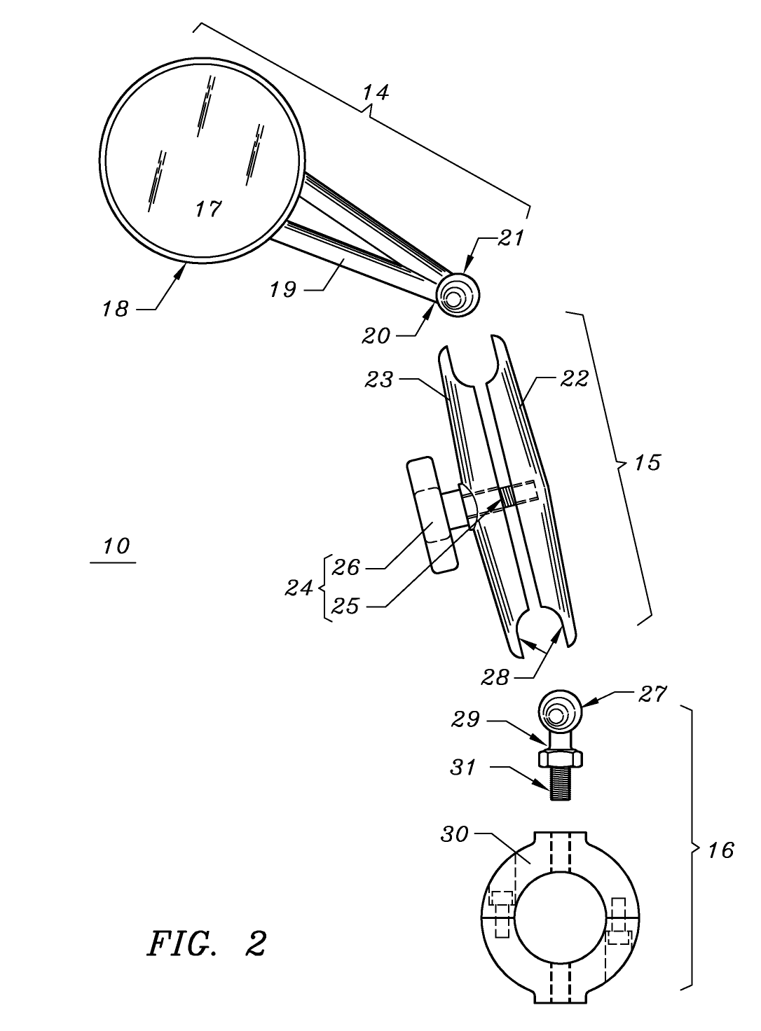

Referring to FIG. 2, a schematic representation of a detailed exploded view of the folding motorcycle mirror 10 from FIG. 1 is shown. The folding motorcycle mirror 10 includes a mirror assembly 14, a clamp assembly 15, and a mount assembly 16. The mirror assembly 14 includes a reflective surface 17 and a mirror holder 18. The mirror holder 18 has a stalk 19 that tapers to a first waist 20 and ends in a first ball 21. The clamp assembly 15 includes a first member 22, a second member 23, and a tensioning mechanism 24. The tensioning mechanism 24 includes a threaded connector 25 and a thumbscrew 26. The first member 22 and the second member 23 may be internally relieved (not shown) to receive the first ball 21 and a second ball 27 in accordance with an embodiment. The tensioning mechanism 24 is configured to tighten the first member 22 with respect to the second member 23 and thus grasp the first ball 21 and the second ball 27. Additionally, the first member 22 and the second member 23 are relieved as shown by reference number 28 so that the first waist 20 and a second waist 29 can fit between the first member 22 and the second member 23 in a variety of positions. The mount assembly 16 includes a conventional barmount 30, a threaded portion 31 that tapers to the second waist 29 and the second ball 27. The conventional barmount 30, the second waist 29, and the second ball 27 may all be part of a single piece in accordance with another embodiment. The conventional barmount 30 has female threads to receive the threaded portion 31 and thus secure the folding motorcycle mirror 10 to the motorcycle (shown in FIG. 1) by means of the handlebar 13 (shown in FIG. 1). According to another embodiment, the conventional barmount 30 may be integrated in a clutch assembly (not shown) or a brake assembly (not shown). While FIG. 2 shows a conventional barmount 30 it should be appreciated by those skilled in the art that the mount assembly may be adapted for placement elsewhere on the motorcycle. For example, the mount assembly may be mounted to or integral with another motorcycle component such as a handguard, a bar end, a fairing, or to another type of barmount in other embodiments.

The first ball 21 and the second ball 27 may be coated with urethane or rubber, or faceted while retaining a generally spherical shape, to increase friction with the inside of the first member 22 and the second member 23. In addition, the relieved portion of the first member 22 and the second member 23 may be treated in these ways as well. This could be advantageous to isolate vibration from the motorcycle or to stiffen the joint.

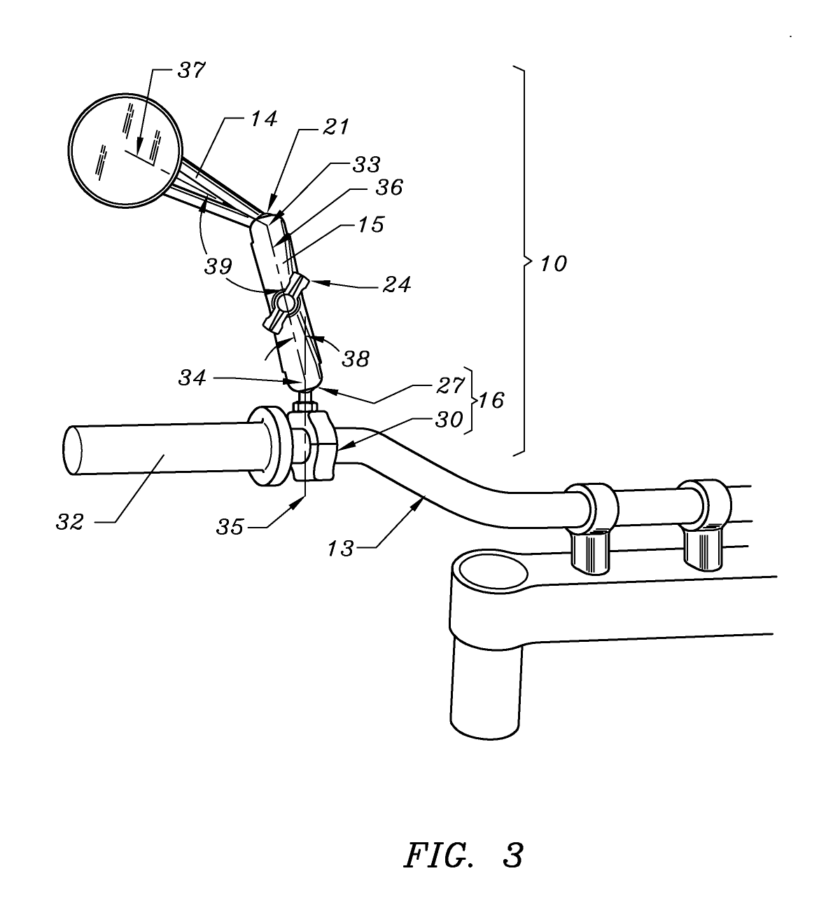

Referring to FIG. 3, a schematic representation of a detailed view of the folding motorcycle mirror 10 from FIG. 1 and FIG. 2 is shown in an extended position. A grip 32 is attached to the handlebar 13. The conventional barmount 30 is shown attached to the handlebar 13 to hold the folding motorcycle mirror 10 in an extended position that would be useful for the rider to observe what is taking place behind. Note that the clamp assembly 15 grasps the first ball 21 of the mirror assembly 14 to form a first joint 33, and the second ball 27 of the mount assembly 16 to form a second joint 34. The first joint 33 and the second joint 34 provide the range of motion necessary to position the mirror assembly 14 in any position the rider 12 (shown in FIG. 1) chooses to optimize viewing, and the tensioning mechanism 24 provides the clamping force necessary to make the first joint 33 and the second joint 34 flexible when required for positioning or stiff when required to be held in place.

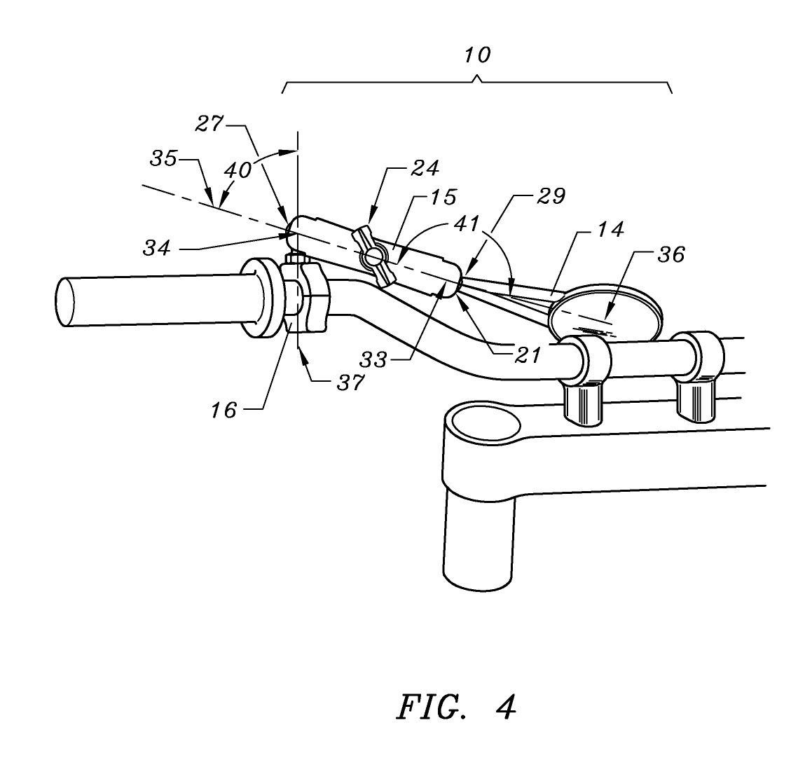

Referring to FIG. 4, a schematic representation of a detailed view of the folding motorcycle mirror 10 from FIG. 1, FIG. 2, and FIG. 3 is shown in a folded position. Again, the clamp assembly 15 grasps the first ball 21 of the mirror assembly and the second ball 27 of the mount assembly 16 to hold the mirror assembly 14 in any position the rider 12 (shown in FIG. 1) chooses where the mirror assembly 14 is most conveniently stowed away along the handlebar 13.

Referring to FIG. 3 and FIG. 4, those skilled in the art will note that to achieve the positions illustrated in FIG. 3 and FIG. 4 requires a bend at both the first joint 33 and the second joint 34, and also a twist at both the first joint 33 and the second joint 34. Known designs with hinges which bend in only one plane do not offer the same function as the first joint 33 and the second joint 34 according to the embodiment shown. When assembled, the term “longitudinal axis of the clamp assembly” 35 is defined to include a line that passes through the center of the first ball 21 and the second ball 27. Further, the term “longitudinal axis of the mount assembly” 37 is defined to include a line passing through the center of the second ball 27 and the center of the second waist 29. Further, the term “longitudinal axis of the mirror assembly” 36 is defined to include a line passing through the center of the reflective surface 17 and through the center of the first ball 21.

According to an embodiment, an angle 40 formed between the longitudinal axis of the clamp assembly and the longitudinal axis of the mount assembly may measure less than 90 degrees. This is possible because the side relief 28 accommodates the second waist 29 at an acute angle. When the folding motorcycle mirror 10 is mounted in another application, it may be desirable for the angle 41 formed between the longitudinal axis of the clamp assembly and the longitudinal axis of the mirror assembly to be less than 90 degrees (not shown).

Those skilled in the art will note that the first joint 33 offers the possibility of twisting the mirror assembly 14 relative to the clamp assembly 15, as well as the possibility to bend in any plane. Further, those skilled in the art will note that the second joint 34 offers the same possibilities for the clamp assembly 15 to rotate or bend relative to the mount assembly 16. By combining both the first joint 33 and the second joint 34 in the folding motorcycle mirror 10, the folding motorcycle mirror is able to conform to any position the rider is likely to desire. The embodiment shown in FIG. 3 and FIG. 4 may be adapted to fit ideally in a wide range of motorcycle designs, handlebar configurations, and rider positions. In addition, the mirror assembly 14 and the clamp assembly 15 may be easily removed without requiring tools should the rider desire to do so, leaving only the mount assembly 16. Known designs typically offer only limited adjustment, with no capacity for repositioning the mirror in multiple planes with respect to the handlebar. Known designs typically do not offer any capacity for easy removal without tools.

Those skilled in the art will further note that a rider could use a gloved hand to adjust the tensioning mechanism 24 and thereby alter the effective stiffness of the first joint 33 and second joint 34. This is desirable so that the rider may apply a light tension to the tensioning mechanism 24, move the mirror assembly 14 through the full range of adjustment offered by the first joint 33 and the second joint 34 to achieve a desired position, either extended or folded, and then tighten the tensioning mechanism 24 to hold the mirror assembly 14 in whatever position was deemed most advantageous. Known designs do not offer adjustable tension. As a consequence, the rider may struggle to position the mirror only for it to fall away from the desired position with exposure to vibration or jarring bumps in the road.

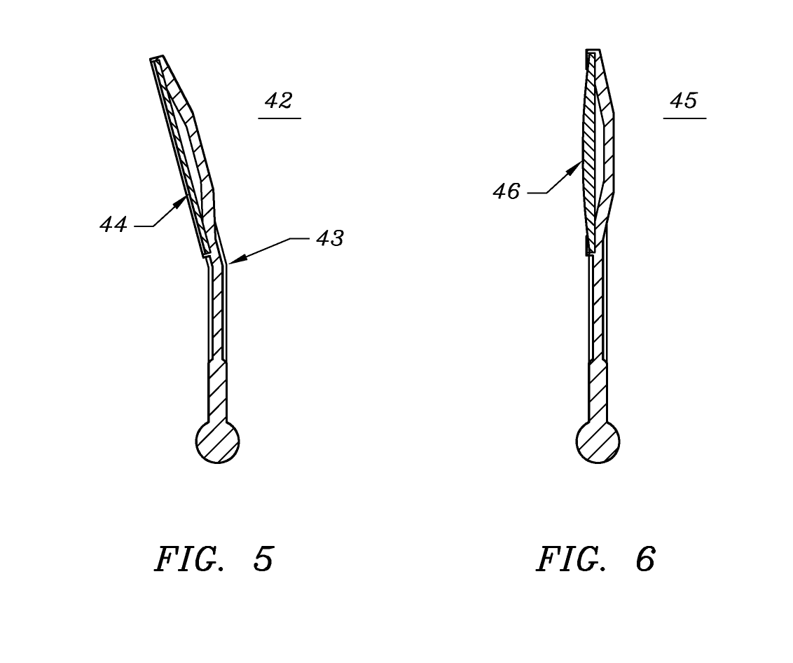

Referring to FIG. 5, a schematic cross-sectional representation of a mirror assembly 42 according to another embodiment is shown. The mirror assembly 42 may include a shaft 43 that is not generally parallel to the reflective surface 44. This embodiment may be desirable depending on the sweep of the handlebars and consequent space available to fold the mirror out of the way. Those skilled in the art will also recognize that it may also be desirable for the shaft to have a bend (not shown) in accordance with other embodiments.

Referring to FIG. 6, a schematic cross-sectional representation of a mirror assembly 45 is shown in accordance with an embodiment. The mirror assembly 45 may be made with a reflective surface 46 that is convex to provide a wider range of view if that is deemed to be advantageous for some situations.

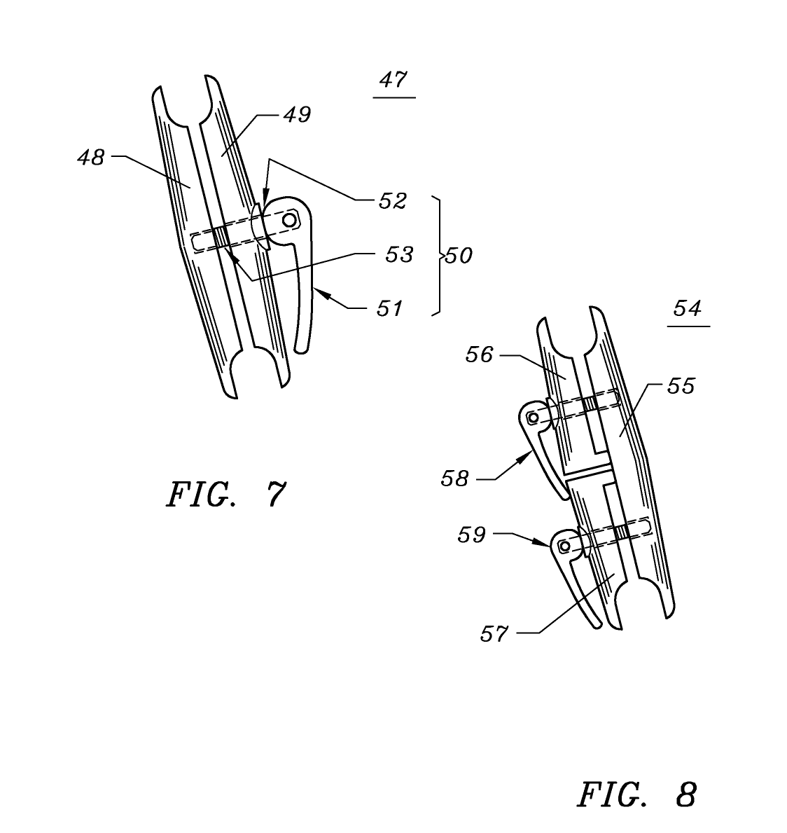

Referring to FIG. 7, a schematic representation of a clamp assembly 47 according to another embodiment is shown. The clamp assembly 47 includes a first member 48 and a second member 49. The clamp assembly 47 may also include a tensioning mechanism 50 that utilizes a lever 51 with a cam 52 for tensioning, possibly in addition to a threaded adjustment 53. The lever 51 and the cam 52 can pull the first member 48 and second member 49 together and thus grip the first ball (not shown) and the second ball (not shown). The amount of force applied on the first member 48 and the second member 49 by the tensioning mechanism 50 determines the relative stiffness of the first joint (not shown) and the second joint (not shown). This design allows for a rider to lessen the stiffness of the first joint and the second joint with a single gloved hand while adjusting the mirror position, and then to tighten them once in position.

Referring to FIG. 8, a schematic representation of a clamp assembly 54 according to another embodiment is shown. The clamp assembly 54 may include a single long member 55, a first short member 56 and a second short member 57. The single long member 55 and the first short member 56 are configured to engage a first ball (not shown). The single long member 55 and the first short member 56 can be pulled together by a first tension mechanism 58. The single long member 55 and the second short member 57 are likewise configured to engage a second ball (not shown) and can be pulled together by a second tension mechanism 59. Those skilled in the art will recognize that in certain applications it may be desirable to have separate control over the stiffness of the first joint (not shown) and the second joint (not shown).

While the invention has been described with reference to preferred embodiments, those skilled in the art will appreciate that certain substitutions, alterations, and omissions may be made the embodiments without departing from the spirit of the invention. Accordingly, the forgoing description is meant to be exemplary only, and should not limit the scope of the invention as set forth in the following claims.

What is claimed is:

1) A folding motorcycle mirror comprising:
a mirror assembly including a first ball;
a mount assembly including a second ball; and
a clamp assembly engaging the first ball and the second ball.

2) The folding motorcycle mirror of claim 1, wherein the mount assembly comprises a mount configured to be attached to a handlebar.

3) The folding motorcycle mirror of claim 1, wherein the clamp assembly comprises a member configured to engage at least one of the first ball and the second ball.

4) The folding motorcycle mirror of claim 1, wherein the clamp assembly comprises a first member configured to engage both the first ball and the second ball, and a second member configured to engage at least one of the first ball and the second ball.

5) The folding motorcycle mirror of claim 4, wherein the clamp assembly further comprises a tensioning mechanism, the tensioning mechanism configured to adjust a clamping force exerted on the first ball by the first member and the second member.

6) The folding motorcycle mirror of claim 4, wherein the clamp assembly further comprises a tensioning mechanism, the tensioning mechanism configured to adjust a clamping force exerted on the second ball by the first member and the second member.

7) The folding motorcycle mirror of claim 5, wherein the tensioning mechanism comprises a lever with a cam.

8) The folding motorcycle mirror of claim 5, wherein the tensioning mechanism comprises a thumbscrew.

9) The folding motorcycle mirror of claim 1, wherein the mirror assembly comprises a reflective surface that is convex.

10) The folding motorcycle mirror of claim 1, wherein at least one of the first ball and the second ball is partially comprised of a vibration isolating compound.

11) The folding motorcycle mirror of claim 10, wherein the vibration isolating compound is selected from a group consisting of rubber and urethane.

12) A folding motorcycle mirror comprising;
a reflective surface connected to a first ball by a stalk;
a mount assembly connected to a second ball by a waist; and
a clamp assembly connecting the first ball and the second ball, the clamp assembly comprising a first member, a second member, and a tensioning mechanism, wherein the clamp assembly is configured to allow the first ball to rotate with respect to the first member, wherein the clamp assembly is further configured to allow the second ball to rotate with respect to the first member.

13) The folding motorcycle mirror of claim 12, wherein the mount assembly comprises a mount configured to be attached to a handlebar.

14) The folding motorcycle mirror of claim 12, wherein the stalk is positioned generally in a plane of the reflective surface.

15) The folding motorcycle mirror of claim 12, wherein an angle between a plane of the reflective surface and a longitudinal axis of the mirror assembly is within 20 degrees.

16) The folding motorcycle mirror of claim 12, wherein the clamp assembly is configured to allow an angle formed between a longitudinal axis of the clamp assembly and a longitudinal axis of the mount assembly to be less than 90 degrees.

17) A folding motorcycle mirror comprising;
a mirror assembly including a reflective surface and a first ball;
a mount assembly including a second ball; and
a clamp assembly attached to the first ball and the second ball, the clamp assembly being adapted to allow the reflective surface to be positioned either in a extended position or in a folded position.

18) The folding motorcycle mirror of claim 17, wherein the mount assembly comprises a mount configured to be attached to a handlebar.

19) The folding motorcycle mirror of claim 17, wherein the folded position comprises positioning the clamp assembly and the mirror assembly generally along a handlebar.

20) The mirror of claim 17, wherein the clamp assembly is configured to put adjustable pressure on both the first ball and the second ball, thereby adjusting the resistance to folding and allowing the mirror to be held firmly in position.

22) The mirror of claim 17, wherein the clamp assembly is configured to adjust pressure on the first ball and the second ball with a single adjustment.

23) The mirror of claim 17, wherein the first ball and the second ball are treated to increase friction with the clamp assembly.
